(19) United States
(12) Patent Application Publication
(10) Pub. No.: US 2012/0239881 A1
(43) Pub. Date: Sep. 20, 2012

(54) INFORMATION DISPLAY DEVICE, METHOD OF DISPLAYING INFORMATION, AND COMPUTER PROGRAM

(75) Inventors: Hideki HAYATSU, Yokohama-shi (JP); Shingo SASAKI, Ota-ku (JP)

(73) Assignee: JVC KENWOOD CORPORATION, Yokohama-shi (JP)

(21) Appl. No.: 13/482,058

(22) Filed: May 29, 2012

Related U.S. Application Data
(63) Continuation of application No. PCT/JP2010/071379, filed on Nov. 30, 2010.

(30) Foreign Application Priority Data
Nov. 30, 2009 (JP) 2009-271749

(51) Int. Cl. G06F 12/02

(52) U.S. Cl. 711/115; 711/E12.002

(57) ABSTRACT

The position relating to a content can be displayed on map information using a portable storage medium. With respect to a content the visual information of which is to be displayed on a display unit (19), a display control unit (control unit 21) displays the visual information of the content on the map information. If a first identification value among a plurality of identification values of the content cannot be found, a content is extracted from the contents stored in the portable storage medium (12) so that the extracted content has an identification value which matches with any of the plurality of identification values other than the first identification value. The visual information of the extracted content is displayed on the map information.

### CROSS-REFERENCE TO RELATED APPLICATION

The present application is a continuation application of International Application No. PCT/JP2010/071379 claiming priority from Japanese Patent Application No. 2009-271749 filed on Nov. 30, 2009, the contents of which are incorporated herein by reference.

### BACKGROUND OF THE INVENTION

1. Field of the Invention

The present invention relates to an information display device, a method of displaying information, and a computer program.

2. Description of Related Art

In recent years, each one of portable terminals such as a PDA (Personal Digital Assistance), a PND (Portable Navigation Device), and the like is able to execute at least two of functions of still image shooting, still image display, video shooting, video replay, music information acquisition, music information replay, telephone communication, e-mail communication, and so on; and furthermore in the case of a PND, it may have a navigation function.

Disclosed in Patent Document 1 is a computer device (for example, a portable terminal) that is able to store various kinds of content together with location information and to display content together with map information. Using such a computer device makes it possible to indicate a location relating to the content on the map information shown on a display unit.

Patent Document 1: JP 2001-134595 A

### SUMMARY OF THE INVENTION

In the case of a computer device disclosed in Patent Document 1 described above, it is indispensable to make an association between content and map information. If the association of the content with the map information is once broken up in the case of the computer device of Patent Document 1, a location corresponding to the content cannot be indicated on the map information.

Assumed in a case described next is that; data constituting a set of content (hereinafter, referred to as data “A”) is once written into a portable storage medium, for example, such as an SD (Secure Digital) memory card (registered trademark) from a first computer device (for example, a portable terminal), and after that, a user inserts the SD memory card into a second computer device (for example, a computer of the user's home) to load the data “A” into the second computer device, and thereafter the data “A” loaded into the second computer device is written into the SD memory card again.

At this time, the same file path as what has been associated with the data “A” at the time of writing the data “A” into the SD memory card from the first computer device is not necessarily associated at the time when the data “A” is written back again into the SD memory card from the second computer device. In other words, at the time when the user writes the data “A” back into the SD memory card from the second computer device; if the user saves the data “A” to an area in the SD memory card specified with a file path that is different from a preceding one, it becomes unclear what content has been replayed and when the content has been replayed.

In such a case, it becomes difficult for the first computer device to trace association between the content and the map information through the file path for the data “A.” Then, the computer device of Patent Document 1 cannot indicate a location corresponding to the content on the map information. Therefore, it is not assumed that a portable storage medium such as an SD memory card is used in the computer device of Patent Document 1.

To be used for portable terminals such as a PDA, a PND, and the like, portable storage media such as an SD memory card are commonly widespread, and therefore it is extremely inconvenient for users if they cannot use such portable storage media.

The present invention has been achieved under the circumstance described above, and it is an object of the present invention to provide an information display device, a method of displaying information, and a computer program that make it possible to view a history of recording/replaying of content as a user's search target, and also to replay the content, even if a portable storage medium having recorded content of the search target is not inserted in an information display device, or even if inserted is another portable storage medium being different from the portable storage medium having the recorded content of the search target.

An aspect of the present invention is with regard to an information device. Namely, an information display device according to the present invention comprises: a memory unit for storing identification information on each content, a plurality of identification values for each content, and history data of recording/replaying the content associated with the identification information on each content, corresponding to identification information of a portable storage medium inserted in the information display device; and a display control unit for displaying visual information, indicating the history data of recording/replaying the content, on map information of a display unit, corresponding to a travel history with regard to a travel of the information display device; wherein, if a first identification value among the plurality of identification values for the content is not found at the time when the visual information of the content as a target for displaying visual information on the display unit is displayed on the map information, the display control unit extracts content being consistent with respect to the plurality of identification values for the content, except the first identification value, out of the content stored in the portable storage medium, and then the display control unit displays visual information of the extracted content on the map information.

For example, the first identification value may be a file path of the content, and the plurality of identification values, except the first identification value, may include at least one of file size, a file hash code, metadata, and a thumbnail path.

Moreover, the display control unit may extract the content by using the file size and the file hash code as a second identification value and a third identification value, respectively.

Furthermore, if the content as a target for displaying visual information on the display unit is not found in the content stored in the portable storage medium being inserted in the information display device, the display control unit may display information with regard to the content as a target, stored in the information display device, as visual information on the map information.

Another aspect of the present invention is with regard to a method of displaying information. Namely, a method of displaying information according to the present invention includes: a step of storing identification information on each content, a plurality of identification values for each content, and history data of recording/replaying the content associated with the identification information on each content, in a memory unit, corresponding to identification information of a portable storage medium inserted in the information display device; and a step of display-controlling in such a way as to display visual information, indicating the history data of recording/replaying the content, on map information of a display unit, corresponding to a travel history with regard to a travel of the information display device; wherein, if a first identification value among the plurality of identification values for the content is not found at the time when the visual information of the content as a target for displaying visual information on the display unit is displayed on the map information, the step of display-controlling extracts content being consistent with respect to the plurality of identification values for the content, except the first identification value, out of the content stored in the portable storage medium, and then the step of display-controlling displays visual information of the extracted content on the map information.

Still another aspect of the present invention is with regard to a computer program. Namely, a computer program according to the present invention for a computer equipped in an information display device for executing a process includes: a step of storing identification information on each content, a plurality of identification values for each content, and history data of recording/replaying the content associated with the identification information on each content, in a memory unit, corresponding to identification information of a portable storage medium inserted in the information display device; and a step of display-controlling in such a way as to display visual information, indicating the history data of recording/replaying the content, on map information of a display unit, corresponding to a travel history with regard to a travel of the information display device; wherein, if a first identification value among the plurality of identification values for the content is not found at the time when the visual information of the content as a target for displaying visual information on the display unit is displayed on the map information, the step of display-controlling extracts content being consistent with respect to the plurality of identification values for the content, except the first identification value, out of the content stored in the portable storage medium, and then the step of display-controlling displays visual information of the extracted content on the map information.

According to the present invention, it is possible to view history data of recording/replaying of content as a user's search target, and also to replay the content, even if a portable storage medium having recorded content of the search target is not inserted in an information display device, or even if inserted is another portable storage medium being different from the portable storage medium having the recorded content of the search target.

### BRIEF DESCRIPTION OF THE DRAWINGS

FIG. 1 is a block diagram of an information display device according to an embodiment of the present invention;

FIG. 2 shows an example of a content table that the information display device according to the embodiment of the present invention has;

FIG. 3 shows an example of a history table of recording/replaying, which the information display device according to the embodiment of the present invention has;

FIG. 4 is a flowchart that shows steps of an image/video shooting process to be carried out by the information display device according to the embodiment of the present invention;

FIG. 5 is a flowchart that shows steps of a post-replay process to be carried out by the information display device according to the embodiment of the present invention;

FIG. 6 is a flowchart that shows steps of a replay process to be carried out by the information display device according to the embodiment of the present invention;

FIG. 7 shows an example of a travel history table that a memory unit of the information display device according to the embodiment of the present invention has;

FIG. 8 shows a display example on a display unit for explaining an application by the information display device according to the embodiment of the present invention;

FIG. 9 shows a display example in the case where content of a still image is selected in the display example shown in FIG. 8;

FIG. 10 is a flowchart that shows steps of an image/video shooting process to be carried out by an information display device according to another embodiment, wherein a content ID is embedded in an SD memory card;

FIG. 11 is a flowchart that shows steps of an image/video shooting process to be carried out by a control unit of an information display device according to another embodiment; wherein a content ID is embedded in an SD memory card, and furthermore various data are also written in a content table;

FIG. 12 is a block diagram of an information display device having a wireless LAN module, according to another embodiment; and

FIG. 13 is a general configuration diagram of an information display system that includes the information display device shown in FIG. 12.

### DETAILED DESCRIPTION OF THE PREFERRED EMBODIMENTS

[With Respect to a Configuration of an Information Display Device 1 According to an Embodiment of the Present Invention]

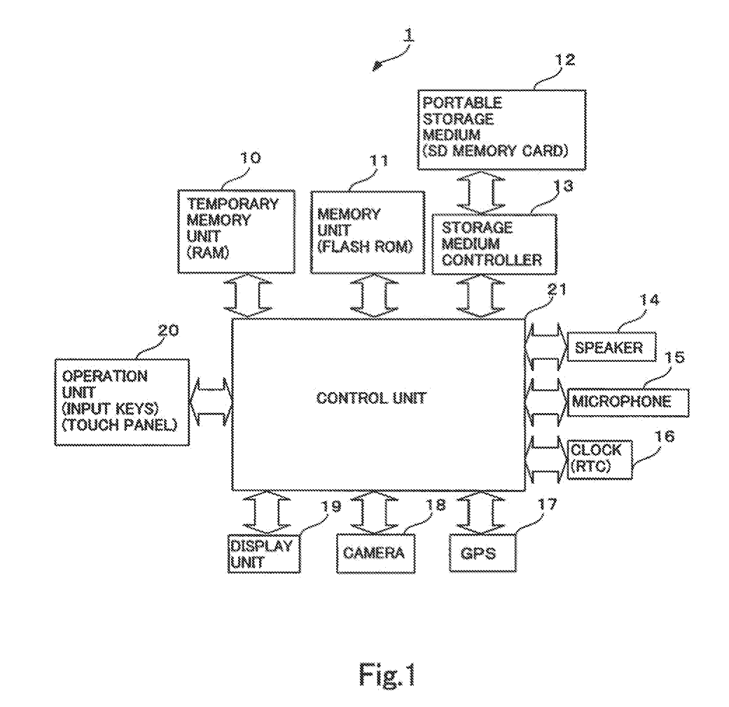

Explained below with reference to FIG. 1 is a configuration of an information display device 1 according to an embodiment of the present invention. FIG. 1 is a block diagram of the information display device 1. The information display device 1 includes a temporary memory unit 10, a memory unit 11, a portable storage medium 12, a storage medium controller 13, a speaker 14, a microphone 15, a clock 16, a GPS (Global Positioning System) 17, a camera 18, a display unit 19, an operation unit 20, and a control unit 21.

The temporary memory unit 10 is a memory, such as a RAM (Random Access Memory), for storing data that is temporarily used by the control unit 21. Incidentally, memory contents of the temporary memory unit 10 may be erased when the information display device 1 is powered off.

The memory unit 11 writes information in, which is transferred from the control unit 21, and also reads out information stored in advance, for the control unit 21. The memory unit 11 includes an HDD (Hard Disc Drive) and/or a nonvolatile memory (such as a flash ROM (Read Only Memory), and the like) that can hold information regardless of whether the information display device 1 is powered on or off. Incidentally, since the information display device 1 is a portable terminal, it indispensably requires reducing in size and weight. Accordingly, it is preferable that the memory unit 11 includes a downsized and lightweight flash ROM rather than an HDD.

The portable storage medium 12 is explained as an SD memory card 12 in the following explanation. Nevertheless, alternatively the portable storage medium 12 may be any portable storage medium other than an SD memory card (for example, a USB (Universal Serial Bus) memory, and the like).

The storage medium controller 13 is an interface that controls data writing and data reading to/from the SD memory card 12. The storage medium controller 13 executes a process under control of the control unit 21.

The speaker 14 outputs voice data when the information display device 1 replays the voice data, such as musical content. Incidentally, instead of, or in addition to the speaker 14, either headphones or earphones may be provided. In such a case, the information display device 1 may be provided with only a connection terminal for those headphones or earphones.

The microphone 15 is used when the information display device 1 records. Moreover, the microphone 15 can also be used in such a case; where a user inputs voice data into the information display device 1, and the control unit 21 analyzes the voice data input by the user for voice recognition on an instruction from the user.

The clock 16 is an RTC (Real Time Clock) for the control unit 21 to recognize the current time.

The GPS 17 measures a current position of the information display device 1 at the time through receiving signals from GPS satellites. Incidentally, any scheme other than GPS may alternatively be used instead of the GPS 17 as far as it enables measurement of a current position of the information display device 1 at the time. For example, if the information display device 1 has a function of a cellular phone unit, the current position can be estimated with reference to positions of base stations from which the information display device 1 receives signals. In another case where the information display device 1 is installed in a car, information on a current position may be obtained by means of the VICS (Vehicle Information and Communication System) in Japan and the like.

The camera 18 is used when the information display device 1 shoots a still image or records a video. The camera 18 includes a CCD (Charge Coupled Device) image sensor, a C-MOS (Complementary Metal Oxide Semiconductor) image sensor, or the like.

The display unit 19 displays various kinds of information (text information, image information, graphic information, and so on) according to control by the control unit 21. Therefore, the display unit 19 is composed of a display unit, such as a liquid crystal display, an OLED (Organic Light Emitting Diode) display, and the like. Additionally, contents of the various kinds of information displayed on the display unit 19 may be output altogether as voice data to the speaker 14 or headphones (or earphones).

The operation unit 20 is used to input operation contents from a user to the control unit 21. For example, the operation unit 20 is a touch panel provided in such a way as to overlap the display unit 19. The touch panel is provided in a manner such that displayed contents on the display unit 19 can be seen through. When a user presses a location on the touch panel, corresponding to an icon indicated on the display unit 19, with a finger and so on, a predetermined operation input enters the control unit 21. Incidentally, for the touch panel, applied may be any type of touch panel operation method (a matrix switch type, a resistive film method, a surface acoustic wave method, an infrared method, an electromagnetic induction type, a capacitance type, etc.). Furthermore, the operation unit 20 may be equipped with a kind of switch such as a push-button switch, a key switch, etc., and/or a pointer function (a function for pointing a certain position on a screen of the display unit 19) such as a mouse.

The control unit 21 includes, for example, a CPU (Central Processing Unit), an ASIC (Application Specific Integrated Circuit), a micro processor (a micro computer), a DSP (Digital Signal Processor), and so on. The control unit 21 controls each of the units described above. What is controlled by the control unit 21 includes; control for displaying various kinds of information on the display unit 19, control for accepting an operation input from the operation unit 20, control for writing information into and reading information out of the temporary memory unit 10 and the memory unit 11, control for writing information into and reading information out of the portable storage medium 12 by means of controlling the storage medium controller 13, control for output of voice data to the speaker 14, control for input of voice data to the microphone 15, control for obtaining a current position data of the information display device 1 at the time by the GPS 17, control for shooting a still image or recording a video by the camera 18, and so on.

Incidentally, the “memory section” mentioned in the claims does not simply refer to the memory unit 11 but a function materialized by the memory unit 11 and the control unit 21 working together in cooperation.

In the following explanation, “content” represents information including music, a still image, a video, writing data such as text data, etc., and the like. In the meantime, a “file” means a memory area in which multiple pieces of data constituting content are stored. Then, “replaying a file” means replaying content such as music, a still image, a video, and the like that are stored in the file. A “file path” is a piece of information for tracing a residence position of the file in a memory. A “file size” represents the total size of data stored in the file. “Metadata” is brief information on content, e.g., when the content is music; specifically, an artist name, an album name, a title of a musical composition, and the like. A “thumbnail” is information with a contracted image that enables recognition of matters of substance of the content, e.g., when the content is a still image, a video, or the like. In the meantime, a “thumbnail path” is a piece of information for tracing a residence position of the thumbnail in a memory.

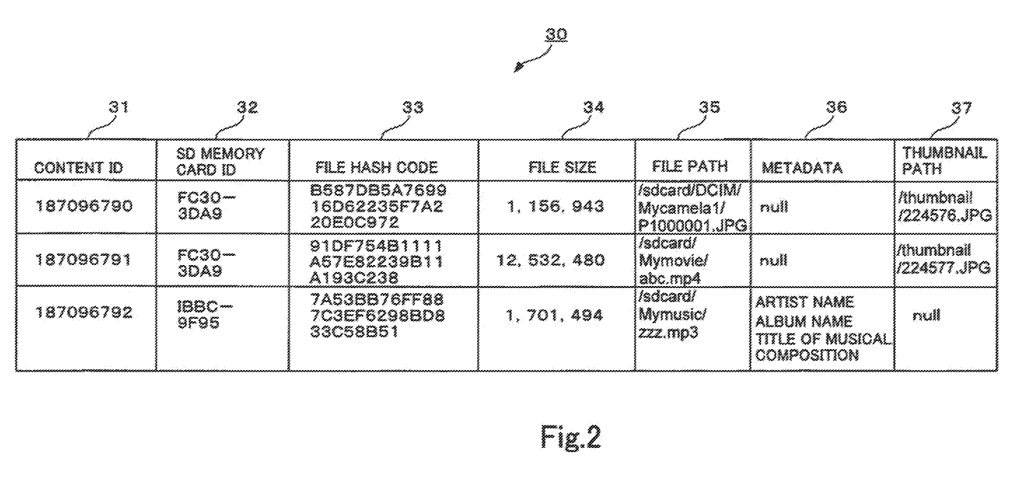

Explained next with reference to FIG. 2 is a content table 30 to be used in the information display device 1. The content table 30 is stored in the memory unit 11 shown in FIG. 1. As shown in FIG. 2, the content table 30 is composed of a content ID 31 (corresponding to the “identification information on each content” mentioned in claims), an SD memory card ID 32 (identification information on an SD memory card), a file hash code 33, file size 34, a file path 35, metadata 36, and a thumbnail path 37. The file hash code 33, the file size 34, the file path 35, the metadata 36, and the thumbnail path 37 are corresponding to the “plurality of identification values for each content” mentioned in claims. In the meantime, the “plurality of identification values except the first identification value” mentioned in claims correspond to the file hash code 33, the file size 34, the metadata 36, and the thumbnail path 37. Then, the file path 35, the file size 34, and the file hash code 33 correspond to the first identification value, a second identification value, and a third identification value, respectively, which are mentioned in claims.

The content ID 31 is an identification number that is defined in the content table 30 at each time when the content is recorded or replayed.

The SD memory card ID 32 is identification information with which each SD memory card 12 is provided beforehand.

The file hash code 33 is a value calculated from data of the content corresponding to the content ID 31 by using a one-way function called “hash function.” Identity of the file can be verified by making use of the file hash code 33. More specifically, when a part of data of a file is updated and subsequently it is checked whether or not the updated file is identical to the file before updating, it is difficult to compare each piece of data constituting the file one at a time. In this case, identity of the file can easily be verified by comparing the file hash codes.

The file size 34 shows data size of original data of the content corresponding to the content ID 31. A unit for the file size 34 is byte (in bytes).

The file path 35 is information for tracing a memory area where the file is stored.

The metadata 36 is metadata for the content corresponding to the content ID 31. When the content is music and the like, mainly recorded as the metadata are an artist name, an album name, a title of a musical composition, and so on. In the meantime, when the content is a still image, a video, or the like; an address, a landmark, and so on according to their longitude and latitude information may be recorded as the metadata.

The thumbnail path 37 is a file path for reading out a thumbnail of the content corresponding to the content ID 31. When the content is mainly a still image, a video, or the like, a contracted image of the still image or the video is recorded as a thumbnail. Incidentally, the thumbnail is stored in the memory unit 11 shown in FIG. 1.

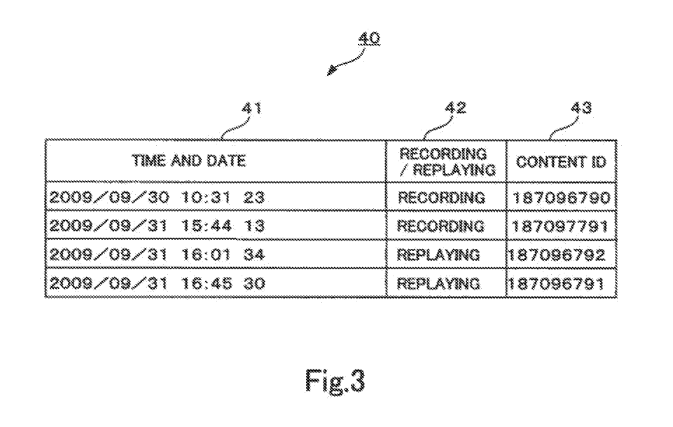

FIG. 3 shows a history table of recording/replaying 40 that the information display device 1 uses. Recorded in the history table of recording/replaying 40 are a time and date when the content is recorded/replayed 41, a distinction between recording the content and replaying the same 42, and a content ID 43.

[With Respect to an Image/Video Shooting Process]

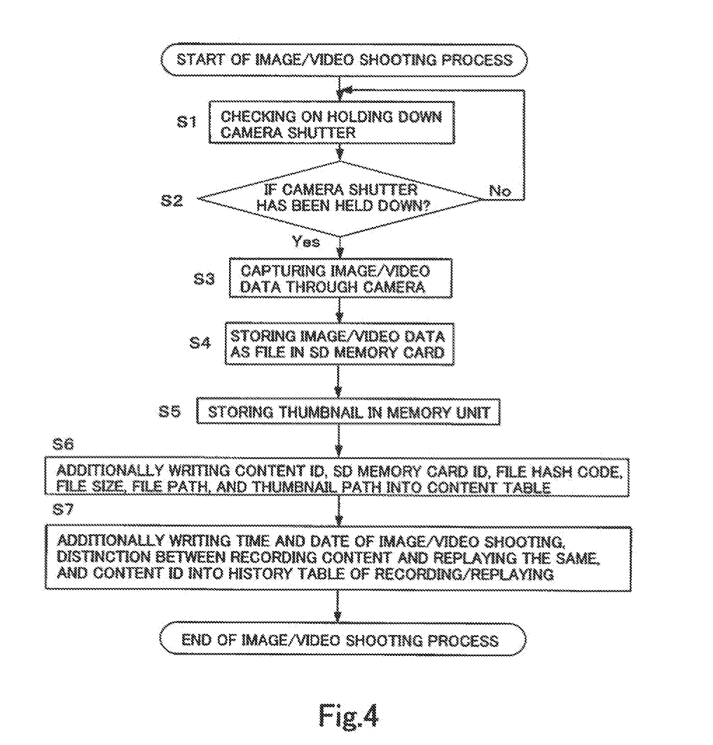

FIG. 4 is a flowchart that shows a workflow of an image/video shooting process in the information display device 1. As an image or a video is shot by using the camera 18 that the information display device 1 has, the control unit 21 starts an image/video shooting process and proceeds to a process of a step S1.

Step S1: The control unit 21 checks on holding down a camera shutter of the camera 18, and proceeds to a process of a step S2.

Step S2: The control unit 21 makes a judgment on whether or not the camera shutter has been held down, according to a result of the process of the step S1. More specifically, in the case where the camera shutter has been held down, as a result of the process of the step S1 (YES at the Step S2), the control unit 21 proceeds to a process of a step S3. Meanwhile, in the case where the camera shutter has not been held down, as the result of the process of the step S1 (NO at the Step S2), the control unit 21 returns to the process of the step S1.

Step S3: The control unit 21 captures image/video data through the camera 18, and proceeds to a process of a step S4.

Step S4: The control unit 21 stores the image/video data as a file in the SD memory card 12, and proceeds to a process of a step S5.

Step S5: The control unit 21 creates a thumbnail for the image/video data and stores it in the memory unit 11, and then the control unit 21 proceeds to a process of a step S6.

Step S6: The control unit 21 additionally writes the content ID 31, the SD memory card ID 32, the file hash code 33, the file size 34, the file path 35, and the thumbnail path 37 into the content table 30, and then proceeds to a process of a step S7.

Step S7: The control unit 21 additionally writes the time and date of image/video shooting 41, the distinction between recording the content and replaying the same 42, and the content ID 43, into the history table of recording/replaying 40, and then finishes the image/video shooting process (an end of the image/video shooting process).

[With Respect to a Post-Replay Process]

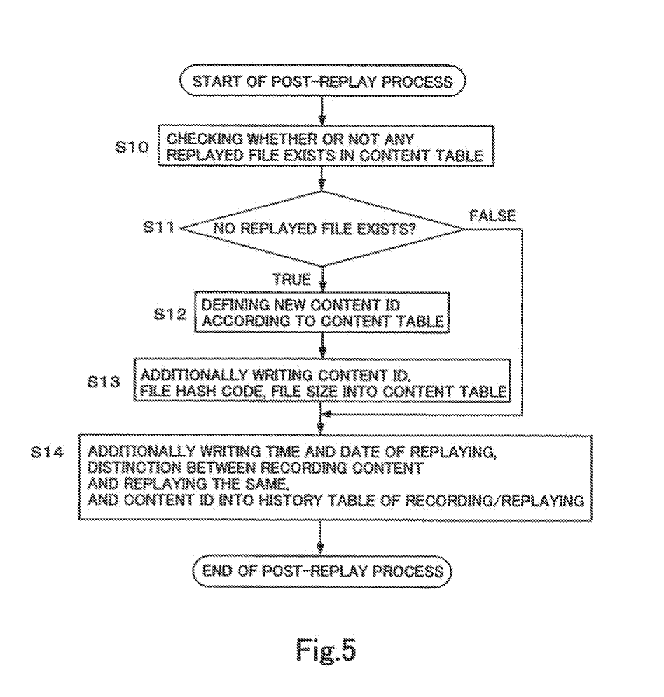

FIG. 5 is a flowchart that shows a workflow of a post-replay process in the information display device 1. After the information display device 1 replays a file, the control unit 21 carries out steps as shown in FIG. 5. In this situation, “replaying a file” represents an operation in which a file written into the SD memory card 12 by another device is replayed by the information display device 1. More specifically, as the file is replayed, the control unit 21 of the information display device 1 proceeds to a process of a step S10.

Step S10: The control unit 21 checks whether or not any replayed file exists in the content table 30, and then proceeds to a process of a step S11. If a replayed file exists, recorded in the content table 30 shown in FIG. 2 at this point are the SD memory card ID 32 of the SD memory card 12 having the replayed file, the file path 35 of the replayed file, the metadata 36 (in the case music data, and the like), and the thumbnail path 37 (in the case of data of a still image, a video, and so on). Meanwhile, at the time, columns of the content ID 31, the file hash code 33, and the file size 34 leave themselves blank (null) in the content table 30.

Step S11: The control unit 21 makes a judgment on whether or not any replayed file exists, according to a result of the process of the step S10. More specifically, in the case where no replayed file exists, as a result of the process of the step S10 (TRUE at the Step S11), the control unit 21 proceeds to a process of a step S12. Meanwhile, in the case where a replayed file exists, as the result of the process of the step S10 (FALSE at the Step S11), the control unit 21 proceeds to a process of a step S 14.

Step S12: The control unit 21 defines a new content ID according to the content table 30, and proceeds to a process of a step S13.

Step S13: The control unit 21 additionally writes the content ID 31 defined in the step S12, the file hash code 33 calculated according to the replayed file, and the file size 34 of the replayed file, into the content table 30, and then proceeds to the process of the step S14. Incidentally, in the case where no replayed file exists at the time of the step S10, the file hash code 33 and the file size 34 may additionally be written beforehand into the content table 30. In this case, the process of the step S13 includes an addition of only the content ID 31 into the content table 30, and then the post-replay process ends.

Step S14: The control unit 21 additionally writes the time and date of replaying content 41, the distinction between recording the content and replaying the same 42, and the content ID 43, into the history table of recording/replaying 40, and then finishes the post-replay process.

[With Respect to a Replay Process]

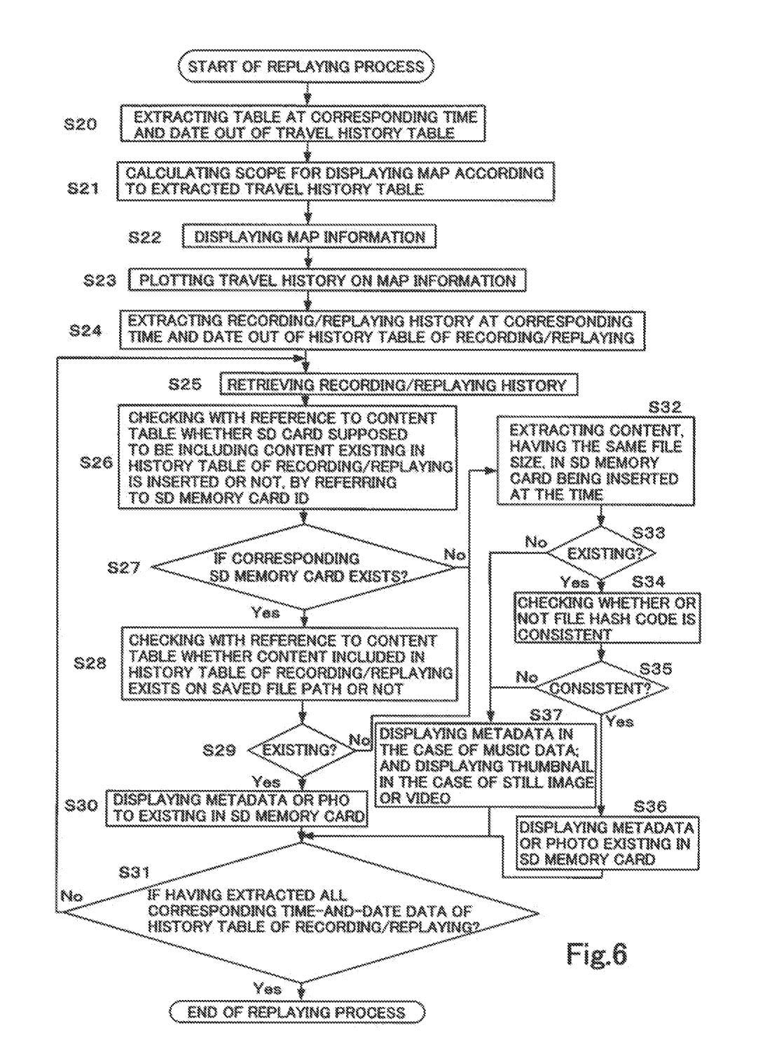

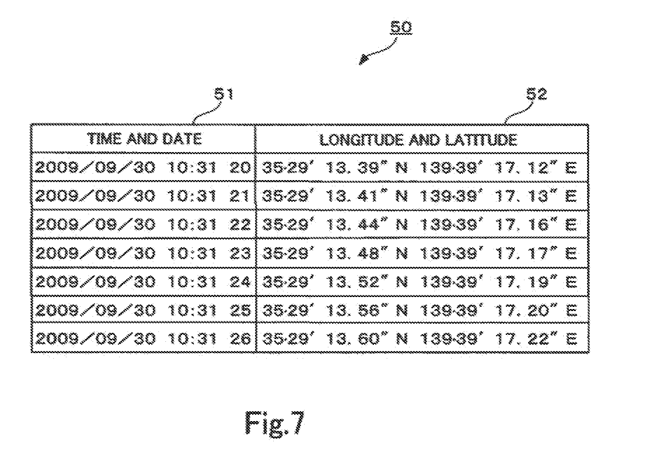

FIG. 6 is a flowchart that shows a workflow of a replay process in the information display device 1. FIG. 7 shows an example of a travel history table 50. In this situation, “a replaying process” means displaying content at a location relating to the content on map information of the information display device 1. The location relating to the content is, for example, a place where the content has been recorded (obtained), or a place where the content has been replayed. Incidentally, the location relating to the content is indicated, for example, by displaying a graphic icon on the map, which symbolically shows matters of substance of the content. As the information display device 1 starts the replaying process, the control unit 21 proceeds to a process of a step S20.

Step S20: On a user's instruction, the control unit 21 extracts a record at a corresponding time and date out of the travel history table 50, and proceeds to a process of a step S21.

Step S21: The control unit 21 calculates a scope for displaying a map according to the travel history table 50 extracted above, and proceeds to a process of a step S22.

Step S22: The control unit 21 displays map information, and then proceeds to a process of a step S23.

Step S23: The control unit 21 plots a travel history on the map information, and proceeds to a process of a step S24. Thus, the travel history is plotted on the map information as a travel route, for example, with a thick solid line or a solid line shown in a color different from the map information, or the like.

Step S24: The control unit 21 extracts a recording/replaying history at the corresponding time and date out of the history table of recording/replaying 40, and proceeds to a process of a step S25.

Step S25: The control unit 21 retrieves the recording/replaying history out of the history table of recording/replaying 40, and proceeds to a process of a step S26.

Step S26: With reference to an association relationship between content ID 31 and the SD memory card ID 32 in the content table 30, the control unit 21 checks whether or not the SD memory card 12 supposed to be including content with the content ID 43 existing in the history table of recording/replaying 40 is inserted in the information display device 1, by referring to an SD memory card ID of the SD memory card 12 inserted in the information display device 1, and proceeds to a process of a step S27.

Step S27: The control unit 21 makes a judgment on whether or not a corresponding SD memory card 12 exists, according to a result of the process of the step S26. More specifically, in the case where the corresponding SD memory card 12 exists, as a result of the process of the step S26 (YES at the Step S27), the control unit 21 proceeds to a process of a step S28. Meanwhile, in the case where the corresponding SD memory card 12 does not exist, as the result of the process of the step S26 (NO at the Step S27), the control unit 21 proceeds to a process of a step S32.

Step S28: With reference to the file path 35 of the content table 30, the control unit 21 checks whether or not content having the content ID 43 included in the history table of recording/replaying 40 exists on a saved file path, and proceeds to a process of a step S29.

Step S29: The control unit 21 makes a judgment on whether or not such content exists on the file path, according to a result of the process of the step S28. More specifically, in the case where the content exists on the file path, as a result of the process of the step S28 (YES at the Step S29), the control unit 21 proceeds to a process of a step S30. Meanwhile, in the case where the content does not exist on the file path, as the result of the process of the step S28 (NO at the Step S29), the control unit 21 proceeds to the process of the step S32.

Step S30: The control unit 21 displays metadata or a photo existing in the SD memory card 12, and proceeds to a process of a step S31. Thus, the metadata (in the case of music, and the like) or the photo is displayed on the map information at a location where the content has been recorded or replayed. Incidentally, the photo may be not in a thumbnail format as far as it is a still image that can be placed within a certain predetermined area. In the case of a video, the photo is in a thumbnail format. Alternatively, a predetermined icon may be displayed instead of such metadata or a photo.

Step S31: If having extracted all the corresponding time-and-date data of the history table of recording/replaying (YES at the Step S31), the control unit 21 finishes the replay process. Meanwhile, if having not yet extracted all the corresponding time-and-date data of the history table of recording/replaying (NO at the Step S31), the control unit 21 proceeds to the process of the step S25.

Step S32: the control unit 21 extracts content, having the same file size, in the SD memory card 12 being inserted in the information display device 1 at the time; and proceeds to a process of a step S33.

Step S33: The control unit 21 makes a judgment on whether or not the content having the same file size exists in the SD memory card 12, according to a result of the process of the step S32. More specifically, in the case where the content having the same file size exists in the SD memory card 12, as a result of the process of the step S32 (YES at the Step S33), the control unit 21 proceeds to a process of a step S34. Meanwhile, in the case where no content having the same file size exists in the SD memory card 12, as the result of the process of the step S32 (NO at the Step S33), the control unit 21 proceeds to a process of a step S37.

Step S34: I the case where the content having the same file size exists in the SD memory card 12, as a result of the process of the step S33, the control unit 21 checks whether or not its file hash code is consistent, and the control unit 21 proceeds to a process of a step S35.

Step S35: The control unit 21 makes a judgment on whether or not the file hash code is consistent, according to a result of the process of the step S34. More specifically, in the case where the file hash code is consistent, as a result of the process of the step S34 (YES at the Step S35), the control unit 21 proceeds to a process of a step S36. Meanwhile, in the case where the file hash code is not consistent, as a result of the process of the step S34 (NO at the Step S35), the control unit 21 proceeds to the process of the step S37.

Step S36: The control unit 21 displays metadata or a photo existing in the SD memory card 12, and proceeds to the process of the step S31. Thus, the metadata (in the case of music, and the like) or the photo is displayed on the map information at a location where the content has been recorded or replayed. Incidentally, the photo may not be in a thumbnail format as far as it is a still image that can be placed within a certain predetermined area. In the case of a video, the photo is in a thumbnail format. Alternatively, a predetermined icon may be displayed instead of such metadata or a photo.

Step S37: The control unit 21 displays metadata in the case of music data; and meanwhile it displays a thumbnail in the case of a still image or a video; and then it proceeds to the process of the step S31.

Thus, as described previously, even in a case where a user saves data into an SD memory card 12, which is different from the previous one, at the time when the user writes the data back to the SD memory card 12 from a computer device (not shown in the figure) so that an SD memory card ID is different from the previous one, the predetermined content can be identified through checking the file size 34 and the file hash code 33 in the content table 30.

Otherwise, as described previously, even in a case where the SD memory card ID is the same as the previous one but the user saves the data into a file, which is different from the previous one in the SD memory card 12, at the time when the user writes the data back to the SD memory card 12 from the computer device so that a file path associated with the data is different from the previous one, the predetermined content can be identified through checking the file size 34 and the file hash code 33 in the content table 30.

Furthermore, even when the content cannot be identified with any of the SD memory card ID 32, the file hash code 33, the file size 34, and the file path 35, the metadata or the thumbnail can be displayed. Thus, the user can make sure of the matters of substance of the content recorded in the SD memory card 12 by visually checking the metadata or the thumbnail displayed on the display unit 19.

On this occasion, if there exist multiple metadata or thumbnails to be displayed, all the metadata or thumbnails can be displayed through changing the display at a constant frequency, or they can be displayed by means of changing the display according to operation by the user.

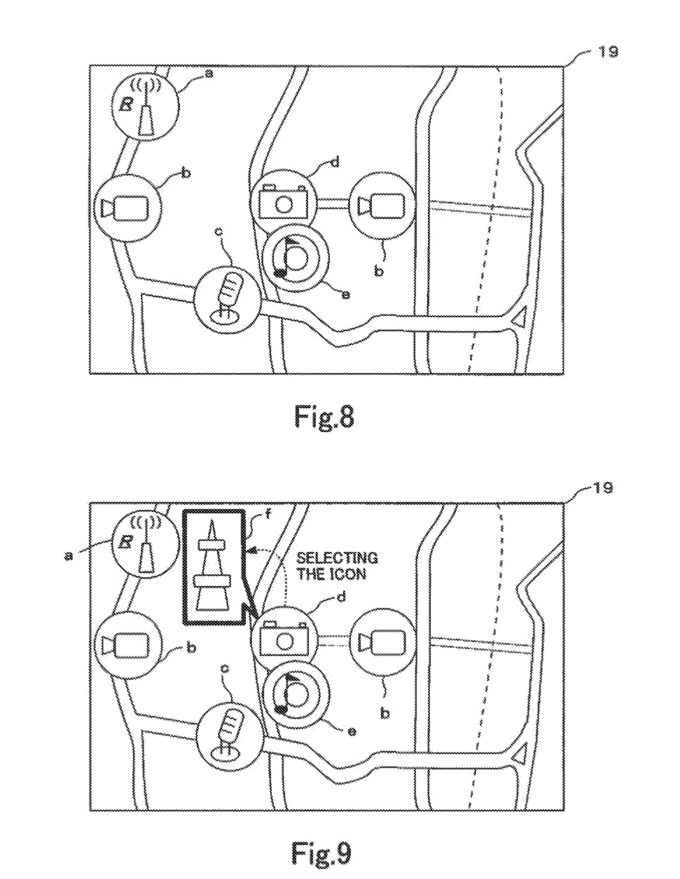

A display example by using the information display device 1 is explained next, with reference to FIG. 8 and FIG. 9. The information display device 1 is able to handle various kinds of content. For example, the information display device 1 is able to handle content such as a history of audio recording of a program, a history of video recording of a program, a history of video shooting, a history of microphone recording, a history of still image shooting, a history of music/video listening & viewing, and the like.

For the history of audio recording of a program and the history of video recording of a program among those kinds of content that can be handled by the information display device 1, an icon “a” showing an image of a situation that a broadcast station is sending radio waves is displayed on the map information of the display unit 19. Then, the icon “a” includes a letter of “It” (meaning “Record”) that represents audio recording & video recording. Incidentally, this kind of content includes not only such a case as receiving radio waves from a broadcast station but also another case as downloading a broadcast through an Internet website and the like for audio recording & video recording.

For the history of video shooting, an icon “b” showing an image of a movie camera is displayed on the map information of the display unit 19.

For the history of microphone recording, an icon “c” showing an image of a microphone is displayed on the map information of the display unit 19.

For the history of still image shooting, an icon “d” showing an image of a still camera is displayed on the map information of the display unit 19.

For the history of music/video listening & viewing, an icon “e” showing an image of a CD (Compact Disc) or DVD (Digital Versatile Disc) is displayed on the map information of the display unit 19.

In an example shown in FIG. 8, each of the icons “a” through “e” displayed on the map information of the display unit 19 is indicated at a position on the map information, such as a start position, an end position, an intermediate position between a start position and an end position, or the like of the corresponding content. It is preferable that these display positions can be changed by the user arbitrarily. In the meantime, the icons “a” through “e” may be displayed together with a travel route.

If the user selects any of the icons “a” through “e” displayed on the map information of the display unit 19 shown in FIG. 8, its corresponding audio-recorded or video-recorded content can be replayed. Incidentally, with respect to a method of selecting each of the icons “a” through “e”; in the case where the operation unit 20 is materialized, for example, with a touch panel overlaid on the display unit 19, an icon can be selected when the user presses a position on the touch panel, corresponding to the objective one of the icons “a” through “e” displayed on the display unit 19, with a finger and so on.

FIG. 9 shows a situation where the icon “d” corresponding to the history of still image shooting has been selected so that a photo “f” is replayed on the display unit 19, wherein the photo “f” being a shot still image. Furthermore, the display unit 19 may also collectively display detailed information such as a name of a created file (including, for example, a place name for the still image shooting, and the like), a time and date for the still image shooting, and so on.

Being not shown in the figure, but recorded audio and/or recorded video is replayed if once the icon “a” corresponding to the history of audio recording of a program and/or the history of video recording of a program has been selected. Furthermore, the display unit 19 may also collectively display detailed information such as a name of a created file (including, for example, a program title, a broadcast station name, and the like), a transmit frequency (URL), a time and date for the audio recording & video recording, and so on.

Being not shown in the figure, but content video-recorded by using the camera 18 or an externally-installed camera (not shown) is replayed if once the icon “b” corresponding to the history of video shooting has been selected. Furthermore, the display unit 19 may also collectively display detailed information such as a name of a created file (including, for example, a name of a video recording source, and the like), a time and date for the video recording, and so on.

Being not shown in the figure, but content audio-recorded by using the microphone 15 or an externally-installed microphone (not shown) is replayed if once the icon “c” corresponding to the history of microphone recording has been selected. Furthermore, the display unit 19 may also collectively display detailed information such as a name of a created file (including, for example, a name of an audio recording source, and the like), a time and date for the audio recording, and so on.

Being not shown in the figure, but internal content is replayed if once the icon “e” corresponding to the history of music/video listening & viewing has been selected. The internal content is what has been written in the memory unit 11 out of the SD memory card 12 or an information supply device 23. In another case where the information display device 1 is internally equipped with a CD player or a DVD player, which are not shown in the figure, the internal content is content of a CD or DVD inserted in those players. Furthermore, the display unit 19 may also collectively display detailed information such as a name of a created file (including, for example, a tune title, a film title, a title of CD/DVD, a broadcast station name, a website name, and the like), a time and date of storing in the memory unit 11, a URL of a download source, and so on.

As historical data of the content is displayed on the map information in this way, it becomes possible to select content according not only to dating data but also to location data. Moreover, various kinds of historical data are displayed on a single screen, and therefore it becomes easy to search movements on the day. The information display device 1 can display the historical data of the content on the map information, while making use of the files stored in the SD memory card 12, as shown in FIG. 8 and FIG. 9.

The information display device 1 according to the embodiment of the present invention can clarify correspondence relationships between the historical data and the content of the information display device 1, through making use of not only 2 sets of data of the SD memory card ID and the file path but also other various sorts of data (the file size and/or the file hash code).

[With Respect to Effects According to the Embodiment of the Present Invention]

Effects according to the embodiment of the present invention are explained below. The information display device 1 makes associations of history data of recording/replaying between the content stored in the SD memory card 12 and the content of the information display device 1, and holds the association data. In addition to the content ID, the SD memory card ID, and the file path of the content, the information display device 1 holds the file hash code of the content and the file size of the content as well.

Thus, at the time when the user writes the data back to the SD memory card 12 from the computer device; even in a case where the user saves data into the SD memory card 12, which is different from the previous one (resulting in different SD memory card IDs), or even in a case where the user saves data into the file, which is different from the previous one in the SD memory card 12, though the SD memory card ID is the same as the previous one (resulting in different file paths); the content can be identified according to a combination of the file size and the file hash code, or the file hash code alone. Therefore, it is possible to find out correspondence relationships between the content and the historical data.

Furthermore, at the time of displaying the travel history and the history data of recording/replaying on the map information while making associations between the both; if the SD memory card 12 deemed to be storing the content as the search target for making associations between the travel history and the history data of recording/replaying is not inserted in the information display device 1, or if the file path for the content as the search target is not found though the SD memory card 12 deemed to be storing the content as the search target is inserted in the information display device 1; content being the same in its file size as the content of the search target is extracted among the content stored in the SD memory card 12 inserted in the information display device 1. Then, if the file hash code of the content is consistent with that of the content as the search target, the data corresponding to the content is displayed on the map information.

Thus, as the file identity is verified through 2-step procedures as described above, operation of verifying the file identity can be carried out surely and quickly. To explain in other words; when the file size and the file hash code are compared each other with respect to their amount of information, the file size has much less amount of information in comparison with the file hash code. Therefore, at first the file identity is verified by using the file size. Then, if the file is verified to be not identical, the following procedure for checking the file by using the file hash code is skipped. Accordingly, the operation of verifying the file identity can be carried out surely and quickly.

Furthermore, if no content having the same file size is found in the content stored in the SD memory card 12 being inserted in the information display device 1, or if the file hash code is not consistent even though the content having the same file size is found, data in relation to the content stored in the SD memory card 12 is displayed on the map information.

Accordingly, when the SD memory card 12 being inserted in the information display device 1 does not have the content that the user needs, the user can check the content existing in the SD memory card 12. Therefore, the user can easily notice that the SD memory card 12 being inserted in the information display device 1 is not the SD memory card 12 having the content that the user needs, and moreover at the same time the user can also check what content the SD memory card 12 has. Thus, the convenience for the user can be improved.

In this way, even if the SD memory card 12 storing the content as the search target is not inserted in the information display device 1, or inserted is another SD memory card 12 different from the SD memory card 12 storing the content as the search target, the information display device 1 makes it possible to view the history data of recording/replaying the content as the user's search target and to replay the content as well.

[With Respect to another Embodiment by making Use of a Program]

The control unit 21 of the information display device 1 may be configured with a general-purpose information-processing unit that operates according to a predetermined program. For example, such a general-purpose information-processing unit includes a memory unit, a CPU (Central Processing Unit), an IO port, and the like. The CPU of the general-purpose information-processing unit loads a control program as the predetermined program out of the memory and the like, and then executes the program. In this manner, the general-purpose information-processing unit performs a function of the control unit 21 of the information display device 1. Moreover, any other functions can also be materialized with a general-purpose information-processing unit and a program as far as it can be materialized by means of software. Incidentally, an ASIC (Application Specific Integrated Circuit), a micro processor (micro computer), a DSP, and the like may be used instead of the CPU described above.

Incidentally, the control program to be executed by the general-purpose information-processing unit may be what is stored in the memory unit of the general-purpose information-processing unit, and the like, before or after shipment of the information display device 1. Otherwise, the control program may be what is prepared by storing a part of the control program in the memory unit of the general-purpose information-processing unit, and the like, after shipment of the information display device 1. The control program to be stored in the memory unit of the general-purpose information-processing unit, and the like, after shipment of the information display device 1 may be what is prepared by installing a program saved in a recording medium readable by a computer, e.g., such as a CD-ROM, or what is prepared by installing a program downloaded by way of a transmission medium such as the Internet.

The control program includes not only a program that can directly be executed by a general-purpose information-processing unit, but also a program that becomes executable by means of installation into a hard disc and the like. Furthermore, the control program also includes what is compressed and/or encrypted.

Thus, based on materialization of the function of the information display device 1 with the general-purpose information-processing unit and the program, it becomes possible to flexibly respond to mass production and specification change (or engineering change).

[With Respect to other Embodiments]

Various other modifications may be made on the embodiments of the present invention without departing from the concept of the present invention.

For example, the content ID may be stored in the SD memory card 12 at the time of the image/video shooting by the camera 18. In this case explained below, such an operation is carried out by a control unit 21A of an information display device 1A.

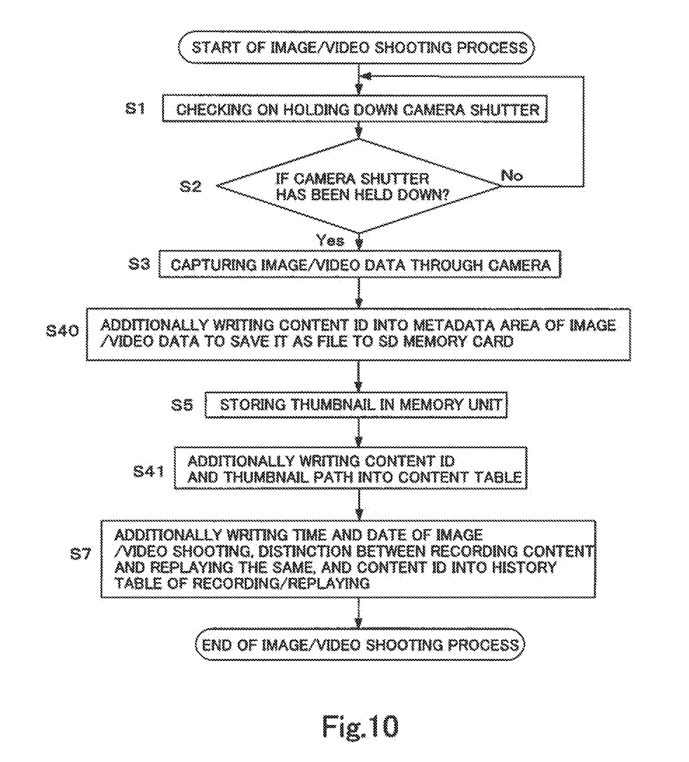

Explained with reference to a flowchart of FIG. 10 is an operation of the control unit 21A (not shown) of the information display device 1A (not shown) to store the content ID of the still image or the video shot by using the camera 18 in the SD memory card 12. In the flowchart of FIG. 10, the processes of the steps S1 through S3, S5 and S7 are the same as those in the flowchart of FIG. 4, and therefore explanations on them are omitted.

Step S40: The control unit 21A additionally writes the content ID into a metadata area of the image/video data to save it as a file to the SD memory card 12, and then proceeds to the process of the step S5.

Step S41: The control unit 21A additionally writes the content ID 31 and the thumbnail path 37 into the content table 30, and then proceeds to the process of the step S7.

According to these steps, the content ID is stored in the metadata area of the SD memory card 12. Therefore, at the processes of the steps S 26 and S27 shown in the flowchart of FIG. 6, the content ID can directly be checked without checking the SD memory card ID 32, instead of the procedures of checking the file path at the steps S 28 and S29. Thus, the processes of the steps S 26 and S27 shown in the flowchart of FIG. 6 can be omitted.

Furthermore, the processes of the steps S 32 through S36 shown in the flowchart of FIG. 6 can be omitted. More specifically, if a “NO” is given at the step S29 in the procedures of the flowchart of FIG. 6, the process of the step S37 is executed directly. Moreover, for the procedure of additionally writing into the content table 30, the content ID 31 and the thumbnail path 37 exclusively are enough to be written.

It may also be possible to store the content ID in the SD memory card 12 and execute calculation on the hash code at the time of the image/video shooting. In this case explained below, such an operation is carried out by a control unit 21B of an information display device 1B.

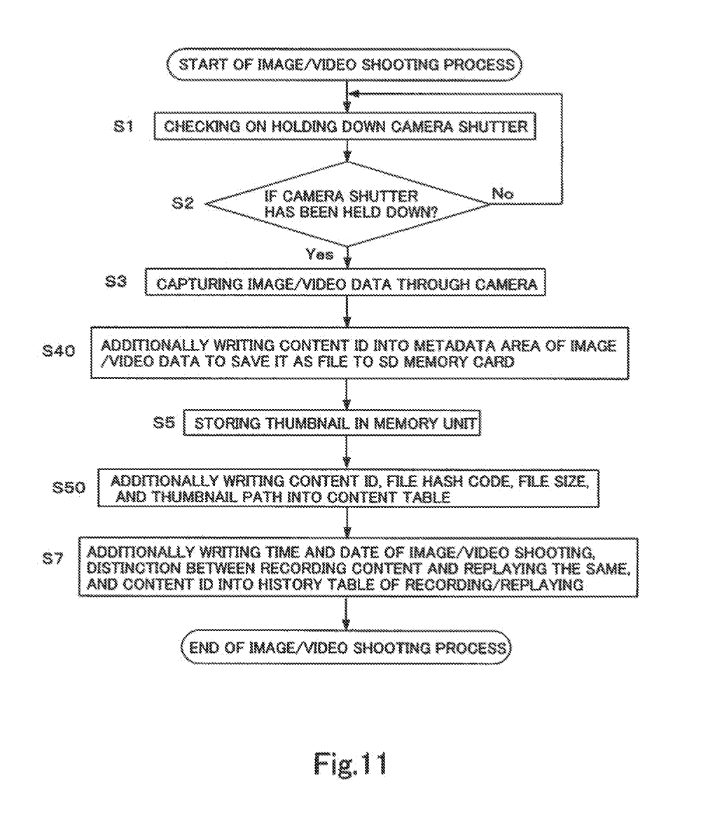

Explained with reference to a flowchart of FIG. 11 is an operation of the control unit 21B (not shown) of the information display device 1B (not shown) to store the content ID of the still image or the video shot by using the camera 18 in the SD memory card 12 and execute calculation on the hash code. In the flowchart of FIG. 11, the processes of the steps S1 through S3, S5 and S7 are the same as those of FIG. 4, while the process of the step S40 is the same as that of FIG. 10, and therefore explanations on them are omitted.

Step S50: The control unit 21B additionally writes the content ID 31, the file hash code 33, the file size 34, and the thumbnail path 37 into the content table 30, and then proceeds to the process of the step S7.

According to these steps, the content ID is stored in the SD memory card 12; and therefore, at the processes of the steps S 26 and S27 shown in the flowchart of FIG. 6, the content ID can directly be checked at the processes of the steps S28 and S29 without checking the SD memory card ID 32. Thus, the processes of the steps S 26 and S27 shown in the flowchart of FIG. 6 can be omitted.

Then, since the file hash code 33, the file size 34, and the thumbnail path 37 are also additionally written into the content table 30, accordingly it becomes possible to check the file size and the file hash code in addition to the content ID. Therefore, the processes of the steps S32 through S37 of the flowchart shown in FIG. 6 can be executed. Thus, the file identity can be verified in the manner; and therefore a chance of erroneous linkage can be further reduced, being compared with that of image/video shooting operation shown in FIG. 10.

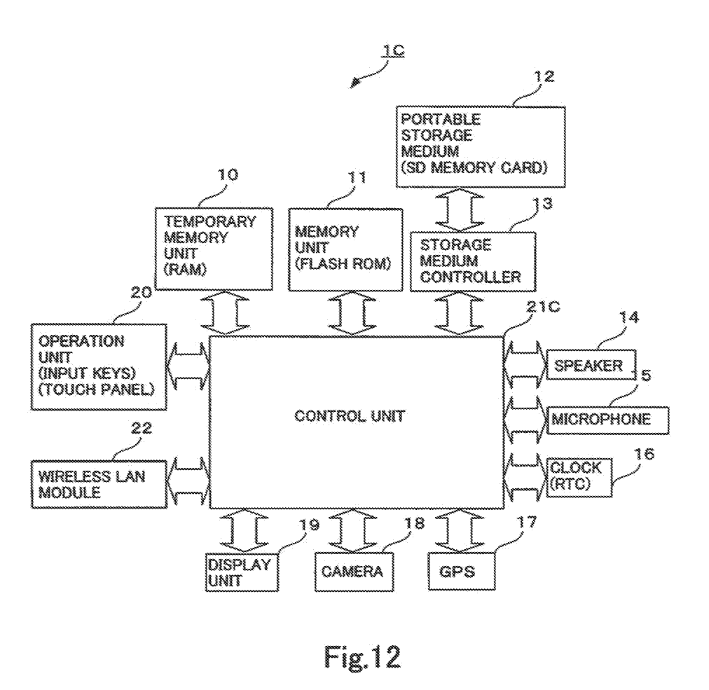

An information display device 1C having a wireless LAN module 22 is explained next with reference to FIG. 12. The information display device 1C shown in FIG. 12 has a configuration further including the wireless LAN module 22 in addition to the configuration of the information display device 1.

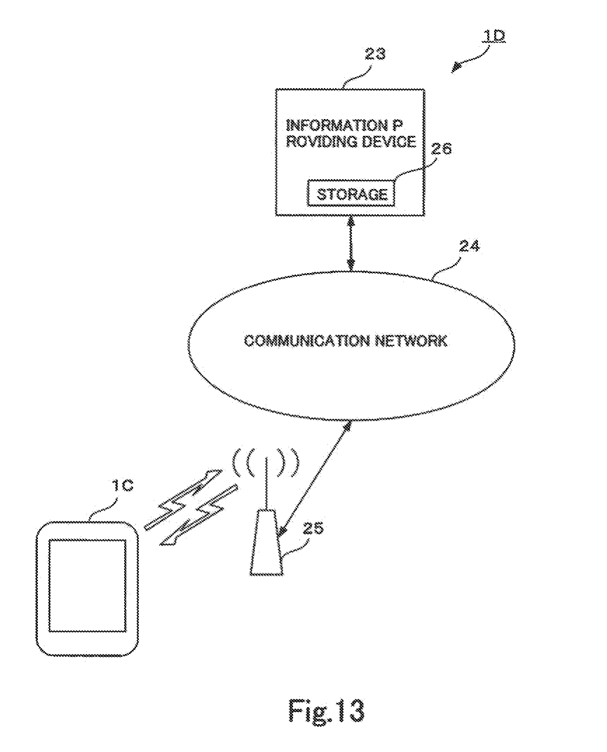

The information display device 1C is used in an information display system 1D, as shown in FIG. 13. The information display system 1D is composed of an information providing device 23, a communication network 24, a wireless base station 25, and the information display device 1C.

The information providing device 23 includes a storage 26, and it can provide various kinds of files stored in the storage 26 to the information display device 1C through the communication network 24 and the wireless base station 25. In this manner, the information display device 1C can make use of a file stored in the storage 26 of the information providing device 23 in addition to a file stored in the SD memory card 12.

For example, in the information display device 1C; when a file path 35 of content (its content ID: 187096792) having an SD memory card ID 32 of “null” being referred to, and the file path is “/server/music1/zzz.mp3”, it means that the content with its content ID: 187096792 exists in the storage 26 of the information providing device 23 (server).

Thus, the information display device 1C can make use of, not only a file of the SD memory card 12 but also such a file stored in the storage 26 of the information providing device 23 in the same manner as the file stored in the SD memory card 12. Accordingly, the number of files, which the information display device 1C is able to use, can be increased to a large extent.

Alternatively, for example, the SD memory card 12 may be replaced with any other portable storage medium. More specifically, an USB memory may be used instead of the SD memory card 12, or an external hard disc drive may be used instead.

In the configurations shown in FIG. 1 and FIG. 12; the speaker 14, the microphone 15, the temporary memory unit 10, and the camera 18 are not indispensable element factors. For example, a file obtained by using an external microphone, an external camera, and the like may be taken in the information display devices 1, 1A, 1B, and 1C by way of the SD memory card 12.

Moreover, the wireless LAN module 22 shown in FIG. 12 is a means of communications not only for wireless LAN; but it may also have a function as a content receiver for receiving content from a broadcast station, an Internet website, or the like; a function of controlling the communication such as telephone communication, mail communication, and so on to/from a wireless base station of a cellular phone system in the case where the information display devices 1, 1A, 1B, and 1C have a function as a cellular phone unit; a function of the communication control for telephone communication or mail communication through a network; or a function of controlling the communication with Bluetooth (a registered trademark) and the like.

Though the icons and the travel route in the example described above are indicated in a monochromatic color, each icon may be indicated in a specific color, depending on the icon type. Furthermore, each icon may be indicated as a moving image or an animation.

Although, described above is an example of displaying “what has been carried out and where it has been done” in chronological order, displayed may be “what has been carried out and where it has been done” in order of coordinates of location information (e.g., in a direction from the north to the south).

Movement information of the information display device 1 by using an acceleration sensor and the like may be added to location information of the information display device 1 by using the GPS 17. According to this manner, location information of the information display device 1 can be estimated even at a place, where it is difficult to obtain location information by using the GPS 1317, e.g., in a tunnel, an underground mall, and so on.

As history data of content, various other sorts of history data in addition to the above-described example may be dealt with, such as history data of playing a game, referring to a dictionary, etc.

For disclosing history data of content, sometimes it may be required to protect privacy. Therefore, it is preferable to implement a measure for protecting privacy, such as entering a password and so on, in advance of displaying information.

In the case where multiple operations are carried out at the same time, for example, viewing a photo while listening to music; corresponding icons are displayed alternately, or icons smaller than an ordinary-sized one are displayed side by side. Alternatively, a setting may be made in such a way as to display historical data on only specific content.

It is preferable that displaying map information can be switched among various display formats with respect to a map scale, a presence of displayed addresses, etc.

Furthermore, without necessarily making associations with map information, history data of recording/replaying with the information display device and the matters of substance of the content in the SD memory card may be displayed in a list form and the like.

Needless to add, information of the content table 30 is not limited to what is described above.

What is claimed is:

1. An information display device comprising:
a memory unit for storing identification information on each content, a plurality of identification values for each content, and history data of recording/replaying the content associated with the identification information on each content, corresponding to identification information of a portable storage medium inserted in the information display device; and
a display control unit for displaying visual information, indicating the history data of recording/replaying the content, on map information of a display unit, corresponding to a travel history with regard to a travel of the information display device;
wherein, if a first identification value among the plurality of identification values for the content is not found at the time when the visual information of the content as a target for displaying visual information on the display unit is displayed on the map information, the display control unit extracts content being consistent with respect to the plurality of identification values for the content, except the first identification value, out of the content stored in the portable storage medium, and then the display control unit displays visual information of the extracted content on the map information.

2. The information display device according to claim 1:
wherein the first identification value is a file path of the content, and
the plurality of identification values, except the first identification value, include at least one of file size, a file hash code, metadata, and a thumbnail path.

3. The information display device according to claim 2:
wherein the display control unit extracts the content by using the file size and the file hash code as a second identification value and a third identification value, respectively.

4. The information display device according to claim 1:
wherein, if the content as a target for displaying visual information on the display unit is not found in the content stored in the portable storage medium being inserted in the information display device, the display control unit displays information with regard to the content as a target, stored in the information display device, as visual information on the map information.

5. A method of displaying information comprising:
a step of storing identification information on each content, a plurality of identification values for each content, and history data of recording/replaying the content associated with the identification information on each content, in a memory unit, corresponding to identification information of a portable storage medium inserted in the information display device; and
a step of display-controlling in such a way as to display visual information, indicating the history data of recording/replaying the content, on map information of a display unit, corresponding to a travel history with regard to a travel of the information display device;
wherein, if a first identification value among the plurality of identification values for the content is not found at the time when the visual information of the content as a target for displaying visual information on the display unit is displayed on the map information, the step of display-controlling extracts content being consistent with respect to the plurality of identification values for the content, except the first identification value, out of the content stored in the portable storage medium, and then the step of display-controlling displays visual information of the extracted content on the map information.

6. A computer program for a computer equipped in an information display device for executing a process comprising:
a step of storing identification information on each content, a plurality of identification values for each content, and history data of recording/replaying the content associated with the identification information on each content, in a memory unit, corresponding to identification information of a portable storage medium inserted in the information display device; and
a step of display-controlling in such a way as to display visual information, indicating the history data of recording/replaying the content, on map information of a display unit, corresponding to a travel history with regard to a travel of the information display device;
wherein, if a first identification value among the plurality of identification values for the content is not found at the time when the visual information of the content as a target for displaying visual information on the display unit is displayed on the map information, the step of display-controlling extracts content being consistent with respect to the plurality of identification values for the content, except the first identification value, out of the content stored in the portable storage medium, and then the step of display-controlling displays visual information of the extracted content on the map information.

7. The information display device according to claim 3:
wherein, if the content as a target for displaying visual information on the display unit is not found in the content stored in the portable storage medium being inserted in the information display device, the display control unit displays information with regard to the content as a target, stored in the information display device, as visual information on the map information.
